(19) United States
(12) Patent Application Publication
(10) Pub. No.: US 2006/0175006 A1
(43) Pub. Date: Aug. 10, 2006

(54) Method for manufacturing electrochemical device

(75) Inventor: Tetsuya Takahashi, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 10/551,275

(22) PCT Filed: Mar. 29, 2004
(86) PCT No.: PCT/JP04/04440

§ 371 Date: Sep. 28, 2005

(30) Foreign Application Priority Data
Mar. 28, 2003 (JP) 2003-091388

(51) Int. Cl. B32B 37/00

(52) U.S. Cl. 156/308.2

(57) ABSTRACT

A method of manufacturing an electrochemical device comprising an electrochemical device matrix 60 including first and second electrodes opposing each other; a case, formed by a first film 51 and a second film 52 which oppose each other, for accommodating the electrochemical device matrix in a closed state; a first lead connected to the first electrode; and a second lead connected to the second lead includes a thermal fusion step of thermally fusing the films 51 and 52 to each other while bringing fringes of the films 51 and 52 into contact with each other and pressing the contact portion of the films 51 and 52, whereas a die 93 (heating member) formed with grooves having respective forms in conformity to forms of cross sections of the leads is used at a part where the first and second leads are placed in the contact portion.

### TECHNICAL FIELD

The present invention relates to a method of manufacturing an electrochemical device; and, more specifically, to a method of manufacturing an electrochemical device including a secondary battery such as lithium-ion secondary battery.

### BACKGROUND ART

Electrochemical capacitors such as electric double layer capacitors and nonaqueous electrolyte secondary batteries such as lithium-ion secondary batteries are electrochemical devices which can easily reduce their size and weight, and thus are expected as power supplies or backup power supplies for portable devices (small-size electronic devices) and auxiliary power supplies for electric cars or hybrid cars, for example.

There is a case where the above-mentioned electrochemical devices used as a backup power supply or auxiliary power supply are required to have a function for smoothing the supplied power by rapidly filling the shortage of power when the main power supply cannot sufficiently follow drastic changes in the load demanded by the electronic devices.

For example, while lithium-ion secondary batteries or fuel batteries have been under study as main power supplies for portable devices (small-size electronic devices), electric cars, or hybrid cars, there is a case where these main power supplies drastically lower their battery voltage when a large current instantaneously flows therethrough because of a drastic change in the load demand, whereby the power may not be supplied appropriately so as to follow the drastic change in load demand (drastic change in current).

Therefore, it has been considered to combine a main power supply and an electrochemical device (electrolytic capacitor or secondary battery) having a relatively large capacity with each other, so as to smooth the power. In particular, it has been considered to combine a main power supply with an electric double layer capacitor having a large capacitor capacity, so as to smooth the power.

In this case, the electrochemical device (electrochemical capacitor or secondary battery) is required to reduce its size and weight as well. Namely, the electrochemical device is needed to improve its energy density per unit weight and its energy density per unit volume at the same time.

Therefore, one configured such that two composite package films (laminate films) comprising a synthetic resin layer and a metal layer such as a metal foil are overlaid on each other, and their fringes are heat-sealed (thermally fused) so as to form a lightweight case (sealing bag), which is used as an exterior container for sealing constituents of an electrochemical device such as a pair of electrodes (anode and cathode) and an electrolyte has been known (see, for example, a nonaqueous electrolyte secondary battery disclosed in Japanese Patent Application Laid-Open No. 2000-294221 and a nonaqueous electrolyte battery disclosed in Japanese Patent Application Laid-Open No. 2000-138040). In this case, respective one end parts of leads made of a metal are electrically connected to the pair of electrodes, whereas the respective other end parts thereof project out of the case.

In this specification, regions of fringes of surfaces on the sides to be heat-sealed (thermally fused) of two films (hereinafter referred to as respective “inner faces” of the films) to become materials of the case are referred to as “seal parts”.

### DISCLOSURE OF THE INVENTION

However, the inventors have found that conventional electrochemical devices using a case such as the batteries disclosed in the above-mentioned Patent Documents 1 and 2 are problematic in that they cannot reliably prevent “leakage”, by which an electrolytic solution filling the case leaks out of the case, from occurring when used under a condition which will follow. When the “leakage” of an electrochemical device occurs, electronic devices mounting the electrochemical device may fail.

As mentioned above, when an electrochemical device to become an auxiliary power supply is required to have a function for smoothing the supplied power by rapidly supplying an amount of power which cannot be supplied by a main power supply, it is desirable that the electrochemical device have an internal resistance as low as possible while being capable of charging and discharging with a large current. Therefore, its leads (current lead-out terminal parts) are desired to have an electric resistance as low as possible, whereby it is desirable to use leads having a cross-sectional area as large as possible.

When leads each having a thickness of 0.05 mm or greater with a cross-sectional area of 5.0×10⁻⁴ or greater (more preferably a thickness of 0.10 mm or greater with a cross-sectional area of 2.0×10⁻³ cm² or greater) are used while being connected to the respective electrodes in order to enable charging and discharging with a large current from the viewpoint mentioned above, the thermal fusion between the seal parts of two films and the leads and/or the thermal fusion between the seal parts of two films about the leads tends to become insufficient, so that holes communicating the inside and outside of the case to each other are very likely to be formed, by which it is problematic in that the “leakage” cannot reliably be prevented from occurring.

More detailed explanations will be given with reference to FIGS. 18A and 18B. FIGS. 18A and 18B are schematic partial sectional views showing leads and their surroundings in seal parts of two films of conventional electrolytic capacitors. FIG. 18A shows a schematic sectional view in a case where a lead 300 is held between two films 100 and 200 and heat-sealed (thermally fused). FIG. 18B shows a schematic sectional view in a case where a lead 300 is further heat-sealed together with an adhesive layer 400 provided between two films 100 and 200 and the lead 300. When the lead 300 has a thickness of 0.05 mm or greater with a cross-sectional area of 5.0×10⁻⁴ cm² or greater, the seal parts of the two films 100 and 200 are not fully fused together about the lead 300 in any of the cases of FIGS. 18A and 18B, so that holes 500 communicating the inside and outside of the case to each other are very likely to be formed.

When the holes 500 communicating the inside and outside of the case to each other are formed, not only the leakage occurs, thereby deteriorating the characteristic and life of the battery, but also the following problems occur in the case where a nonaqueous electrolytic solution (a solution containing an organic compound) is used as an electrolytic solution. Namely, air flows in from the outside, so that the moisture contained in the air reacts with the nonaqueous electrolytic solution, thereby generating an acid, which corrodes constituents of the device, and oxygen contained in the air advances oxidation reactions of organic compounds, thereby denaturing the electrolytic solution, etc., which are problematic, so that the characteristic and life of the battery deteriorate from this viewpoint as well.

In view of the above-mentioned problems inherent in the prior art, it is an object of the present invention to provide a method of manufacturing an electrochemical device which can easily and reliably form a case having an excellent sealability even when a lead having a thickness of 0.05 mm or greater with a cross-sectional area of 5.0×10⁻⁴ cm² or greater is used, while having such an excellent reliability that the leakage can fully be prevented from occurring.

The inventors conducted diligent studies in order to achieve the above-mentioned object and, as a result, have found that employing the following heat treatment process is quite effective in achieving the above-mentioned object when manufacturing an electrochemical device including a case formed by using a film while utilizing a lead having a thickness of 0.05 mm or greater with a cross-sectional area of 5.0×10⁻⁴ cm² or greater, thereby achieving the present invention.

Namely, the present invention provides a method of manufacturing an electrochemical device comprising an electrochemical device matrix including first and second electrodes opposing each other; a case, formed by first and second films opposing each other, for accommodating the electrochemical device matrix in a closed state; a first lead having one end part connected to the first electrode and the other end part projecting out of the case; and a second lead having one end part connected to the second electrode and the other end part projecting out of the case; the method including a thermal fusion step of arranging the first and second films such that respective fringes thereof are in contact with each other between a pair of heating members opposing each other, and heating at least one of the pair of heating members while a contact portion of the fringes is pressed, so as to thermally fuse the first and second films to each other; wherein at least one of the pair of heating members is formed with grooves having respective forms in conformity to forms of cross sections of the first and second leads at a part where the first and second leads are placed between the fringes of the first and second films.

In the present invention, the “groove having a form in conformity to the cross section of the first lead” in the “groove having a form in conformity to the cross section of the first lead” in the heating member has a form and a size which are determined beforehand theoretically or experimentally in view of the thickness of each film brought into close contact with the first lead while being thermally deformed at the time of thermal fusion and the cross-sectional form of each film in a state in close contact with the first lead in addition to the cross-sectional form of the first lead and the size thereof.

Therefore, when the first lead has a substantially rectangular cross-sectional form, for example, a groove of a heating member may be formed such as to have a cross-sectional form and a size which are similar to those of the first lead, or may be formed substantially trapezoidal, for example, in view of the thicknesses and cross-sectional forms of the first and second films brought into close contact with the first lead while being thermally deformed as shown in FIG. 15 which will be explained later.

On the other hand, the “groove having a form in conformity to the cross section of the second lead” in the “groove having a form in conformity to the cross section of the second lead” in the heating member has a form and a size which are determined theoretically or experimentally in view of the thickness of each film brought into close contact with the second lead while being thermally deformed at the time of thermal fusion and the cross-sectional form of each film in a state in close contact with the second lead in addition to the cross-sectional form of the second lead and the size thereof.

In the present invention, the “electrochemical device matrix” refers to a laminate including at least first and second electrodes opposing each other, while (1) a separator formed from an insulative material or (2) a solid electrolyte film (a film made of a solid polymer electrolyte or a film containing an ionically conductive inorganic material) is arranged between the first and second electrodes. In the configuration of (1) mentioned above, the first electrode, second electrode, and separator may contain therein an electrolytic solution or a solid electrolyte (a solid polymer electrolyte or an electrolyte made of an ionically conductive inorganic material). The “electrochemical device matrix” may also have a configuration composed of five or more layers in which the above-mentioned electrodes and separators (or solid electrolyte films) are alternately laminated instead of the three-layer structure such as the configurations of (1) and (2) mentioned above.

In the present invention, the “electrochemical device” refers to a device comprising, at least, the above-mentioned electrochemical device matrix; a case, formed by first and second films opposing each other, for accommodating the electrochemical device matrix in a closed state; a first lead having one end part connected to the first electrode and the other end part projecting out of the case; and a second lead having one end part connected to the second electrode and the other end part projecting out of the case.

More specifically, the “electrochemical device” preferably refers to a secondary battery or electrochemical capacitor. Preferred examples of the secondary battery include nonaqueous electrolyte secondary batteries such as lithium-ion secondary batteries using nonaqueous electrolytes, and secondary batteries using electrolytic aqueous solutions. Examples of the electrochemical capacitor include electric double layer capacitors, pseudocapacity capacitors, and redox capacitors. From the viewpoint of being used as an auxiliary power supply capable of smoothly charging and discharging with a large current, the “electrochemical device” more preferably refers to the above-mentioned electrochemical capacitor, further preferably an electric double layer capacitor.

In the present invention, it is sufficient for the “first lead” to be electrically connected to the first electrode. For example, other electronically conductive members may be disposed between the “first lead” and the first electrode. Similarly, it is sufficient for the “second lead” to be electrically connected to the second electrode.

In the present invention, the “heating member” may be a heating element itself or a thermal conductor which supplies heat from other heating elements as long as it can supply the first and second films with heat by which they can thermally be fused to each other. In the manufacturing method of the present invention, it is sufficient for the thermal fusion step to heat at least one of the pair of heating members.

In the present invention, the “film” refers to a flexible film adapted to be thermally fused to a film of the same species and to a lead made of a metal.

When heating members formed with grooves having forms and sizes of the first and second leads are used as mentioned above, the respective seal parts of the films are brought into close contact with surfaces of the first and second leads while being deformed in conformity to the forms thereof at the time of thermal fusion. Therefore, the thermal fusion can be carried out in a state where the seal part of each film is fully in contact with the whole surface of each of the first and second leads. As a result, sealability can sufficiently be secured in portions surrounding the first and second leads in the seal parts of the films, whereby the leakage can fully be prevented from occurring.

Therefore, even when leads each having a thickness of 0.05 mm or greater with a cross-sectional area of 5.0×10⁻⁴ cm² or greater are used as the first and second leads, the manufacturing method of the present invention can sufficiently achieve the adhesion between the leads and films. Hence, an electrochemical device which can form a case with an excellent sealability easily and reliably while having such an excellent reliability as to be able to sufficiently prevent the leakage from occurring can be provided even when a lead having a thickness of 0.05 mm or greater with a cross-sectional area of 5.0×10⁻⁴ cm² or greater is used.

Since a case formed by using films which is light in weight and has such a flexibility as to be easy to become thinner is used, the electrochemical device itself can easily be formed like a thin film. Therefore, the manufacturing method of the present invention can easily construct an electrochemical device having a structure which can easily reduce its size and weight. This can easily improve the original volume energy density, and the energy density per unit volume of a space where the electrochemical device is to be placed (which will hereinafter be referred to as “volume energy density based on the volume of the space to be placed”).

The “volume energy density” of the electrochemical device is originally defined by the ratio of the whole output energy to the whole volume including the container of the electrochemical device. On the other hand, the “volume energy density based on the volume of the space to be placed” refers to the ratio of the whole output energy of the electrochemical device to the apparent volume of the electrochemical device determined according to the maximum length, maximum width, and maximum thickness thereof. When mounting the electrochemical device to a small-size electronic device in practice, improving the volume energy density based on the volume of the space to be placed as well as the above-mentioned original volume energy density is important from the viewpoint of effectively utilizing the limited space within the small-size electronic device while in a state where the dead space is fully reduced.

The method of manufacturing the electrochemical device in accordance with the present invention may be characterized in that leads made of a metal each having a thickness of 0.05 to 3.00 mm are used as the first and second leads.

The method of manufacturing an electrochemical device in accordance with the present invention can sufficiently secure the adhesion of the first and second leads to the seal parts of the first and second films as mentioned above, whereby an electrochemical device having an excellent reliability can be formed easily and reliably even when leads falling within the above-mentioned thickness range are used. When an electric double layer capacitor is constructed with a capacitor capacity of 100 to 2000 F while using leads falling within the above-mentioned thickness range, charging and discharging with a current of 10 to 200 A can easily be performed.

When the first and second leads have a thickness of less than 0.05 mm, they are harder to handle since their mechanical strength is insufficient. When the first and second leads have a thickness greater than 5.00 mm, on the other hand, it is difficult to construct a thin electrochemical device having a thickness of 5.0 mm or less, whereby the above-mentioned “volume energy density based on the volume of the space to be placed” is harder to secure sufficiently.

From the viewpoint of constructing a thin electrochemical device capable of charging and discharging with a relatively large current, it will be more preferable in the method of manufacturing an electrochemical device in accordance with the present invention if leads having a thickness of 0.1 to 2.00 mm are used as the first and second leads.

Preferably, in the method of manufacturing an electrochemical device in accordance with the present invention, a portion coming into contact with the first and second leads in the fringe to be thermally fused in at least one of the first and second films is deformed by drawing beforehand so as to have respective forms and sizes in conformity to forms and sizes of cross sections of the first and second leads, and then the thermal fusion step is carried out. More preferably, both of the portion coming into contact with the first and second leads in the fringe to be thermally fused in the first film and the portion coming into contact with the first and second leads in the fringe to be thermally fused in the second film are subjected to the drawing beforehand.

This can more reliably yield the above-mentioned effects of the present invention. In particular, an electrochemical device which can fully prevent the leakage from occurring even when a lead having a thickness of 0.10 mm or greater with a cross-sectional area of 2.0×10⁻³ cm² or greater is used while being connected to an electrode can be constructed more easily and more reliably.

Here, the “drawing” refers to a process for effecting so-called deep drawing, which is carried out by a drawing machine whose die is covered with a film heated when necessary, and the film is extended such that only the form of the film in the above-mentioned portion of the seal part is selectively drawn (by draw thermoforming or forming using pressure forming in addition to draw thermoforming), so as to yield a form in conformity to the forms and sizes of respective cross sections of the first and second leads, and is subsequently subjected to forming with cooling when necessary.

When the fringes to be thermally fused in the first and second films are subjected to the above-mentioned drawing, the method of manufacturing an electrochemical device in accordance with the present invention may be characterized in that leads made of a metal preferably having a thickness of 0.10 mm or greater, more preferably 0.10 to 5 mm, further preferably 0.50 to 2.00 mm, are used as the first and second leads, since an electrochemical device which can fully prevent the leakage from occurring can be constructed more easily and more reliably. This can easily and reliably construct a thin electrochemical device capable of charging and discharging with a relatively large current.

From the viewpoint of constructing a thin electrochemical device capable of charging and discharging with a relatively large current, the method of manufacturing an electrochemical device in accordance with the present invention preferably uses leads made of a metal having a cross-sectional area of 5.0×10⁻⁴ to 1.0 cm², more preferably 0.01 to 0.04 cm², as the first and second leads.

Preferably, in the method of manufacturing an electrochemical device in accordance with the present invention, electrodes each having a flat form and containing an electronically conductive porous body as a constituent material are used as the first and second electrodes, a member made of a porous body having a flat form, an ion permeability, and an insulating property is used as a separator, and an electrolytic solution fills the case such that the electrolytic solution is at least partly contained in the first and second electrodes and the separator.

As a consequence, a laminate (hereinafter referred to as “matrix” of the electrochemical device when necessary) constituted by the first electrode, separator, and second electrode can be formed like a thin film, whereby the electrochemical device itself can be formed like a thin film more easily and reliably. Therefore, an electrochemical device having a configuration which makes it easy to reduce the size and weight can be constructed more easily.

Preferably, in the method of manufacturing an electrochemical device in accordance with the present invention, a composite package film comprising at least an innermost layer made of a synthetic resin in contact with an electrolytic solution and a metal layer disposed above the innermost layer is used as the first and second films.

Placing the innermost layer made of a synthetic resin secures a sufficient flexibility in the first and second films, and can sufficiently ensure the thermal fusion strength between the respective seal parts of the first and second films. Placing the metal layer secures a sufficient mechanical strength in the first and second films, and can fully prevent constituents of the electrolytic solution within the case from dissipating to the outside of the case and air (moisture and oxygen) from flowing into the case from the outside. Placing the innermost layer made of a synthetic resin on the inner side of the metal layer fully prevents constituents of the electrolytic solution and the like within the case from corroding the metal layer.

This can more easily and more reliably construct an electrochemical device which can fully prevent the leakage from occurring. From the viewpoint of fully preventing the leakage from occurring and securing a sufficient mechanical strength, it will be more preferable if a layer made of a synthetic resin is disposed on the outside of the metal layer.

Preferably, in the method of manufacturing an electrochemical device in accordance with the present invention, an adhesive made of a synthetic resin is thermally fused or applied beforehand to a surface portion of the first lead coming into contact with the fringe of the first film to be thermally fused and the fringe of the second film to be thermally fused, and an adhesive made of a synthetic resin is applied beforehand to a surface portion of the second lead coming into contact with the fringe of the first film to be thermally fused and the fringe of the second film to be thermally fused, and then the thermal fusion step is carried out.

As a consequence, the bonding state between the metal and the composite package film becomes favorable, and a layer made of the above-mentioned adhesive is formed about the first and second leads, whereby the sealability of the respective seal parts of the first and second films is fully secured in the portions surrounding the first and second leads.

Preferably, in the case mentioned above, an adhesive containing at least one species of resin selected from the group consisting of denatured polypropylene, denatured polyethylene, and epoxy resin is used as the adhesive made of a synthetic resin.

In the present invention, the “electrolytic solution” is not only in a liquid state, but may also be a gel-like electrolyte obtained by adding a gelling agent thereto.

### BRIEF DESCRIPTION OF THE DRAWINGS

FIG. 1 is a front view showing an example of electrochemical device (electric double layer capacitor) manufactured by a preferred embodiment of the manufacturing method in accordance with the present invention;

FIG. 2 is an unfolded view of the inside of the electrochemical device (electric double layer capacitor) shown in FIG. 1 as seen in a direction normal to the surface of an anode 10;

FIG. 3 is a schematic sectional view of the electrochemical device (electric double layer capacitor) taken along the line X1-X1 of FIG. 1;

FIG. 4 is a schematic sectional view showing a major part of the electrochemical device (electric double layer capacitor) taken along the line X2-X2 of FIG. 1;

FIG. 5 is a schematic sectional view showing a major part of the electrochemical device (electric double layer capacitor) taken along the line Y-Y of FIG. 1;

FIG. 6 is a schematic sectional view showing an example of basic configuration of a film to become a constituent material for a case of the electrochemical device (electric double layer capacitor) shown in FIG. 1;

FIG. 7 is a schematic sectional view showing another example of basic configuration of a film to become a constituent material for the case of the electrochemical device (electric double layer capacitor) shown in FIG. 1;

FIG. 8 is a schematic sectional view showing an example of basic configuration of the anode in the electrochemical device (electric double layer capacitor) shown in FIG. 1;

FIG. 9 is a schematic sectional view showing an example of basic configuration of a cathode in the electrochemical device (electric double layer capacitor) shown in FIG. 1;

FIG. 10 is an explanatory view for explaining a step of preparing an electrode forming coating liquid;

FIG. 11 is an explanatory view for explaining a step of forming an electrode sheet using the electrode forming coating liquid;

FIG. 12 is an explanatory view for explaining a step of forming the electrode sheet using the electrode forming coating liquid;

FIGS. 13A to 13C are explanatory views for explaining steps of forming an electrode from the electrode sheet;

FIGS. 14A to 14C are explanatory views for explaining a procedure of drawing a seal part 51B of a first film 51;

FIG. 15 is an explanatory view for explaining a procedure of thermally fusing surroundings of an anode lead conductor 12 to the first film 51 and a second film 52 by a thermal fusion step;

FIG. 16 is an explanatory view showing an example of procedure of filling the case with an electrolytic solution;

FIG. 17 is a perspective view showing the electrochemical device when seal parts of the case are bent; and

FIGS. 18A and 18B are schematic partial sectional views showing surroundings of a lead in seal parts of two films in a conventional electrolytic capacitor.

### BEST MODES FOR CARRYING OUT THE INVENTION

In the following, a preferred embodiment of the method of manufacturing an electrochemical device in accordance with the present invention will be explained in detail. In the following explanation, parts identical or equivalent to each other will be referred to with numerals identical to each other without repeating their overlapping descriptions.

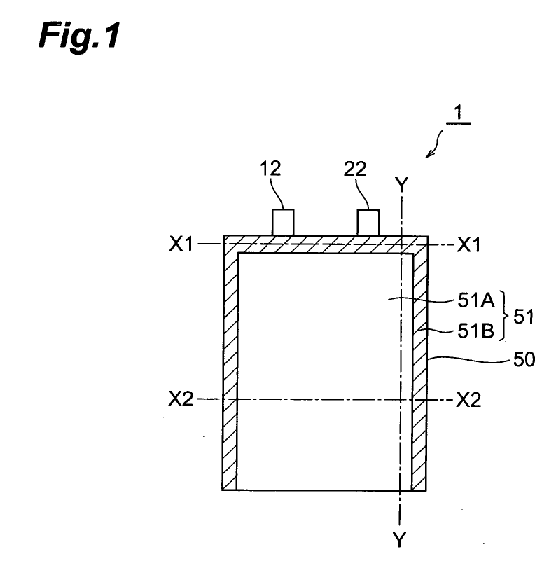

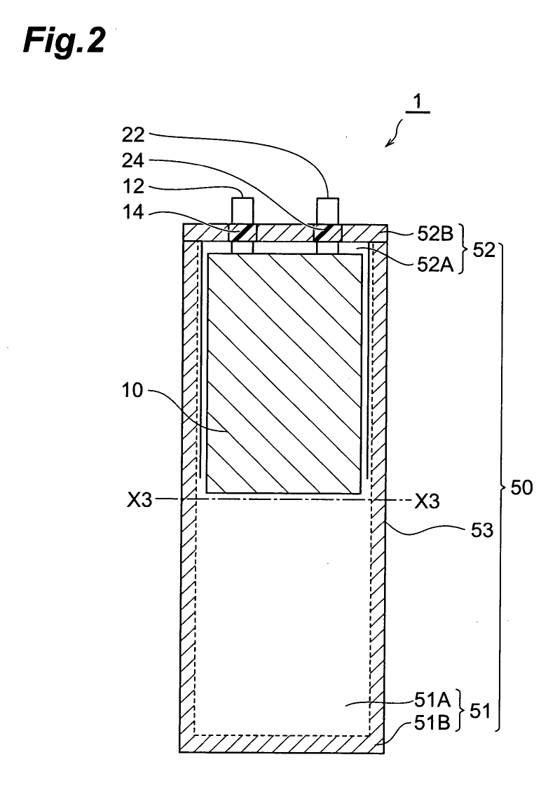

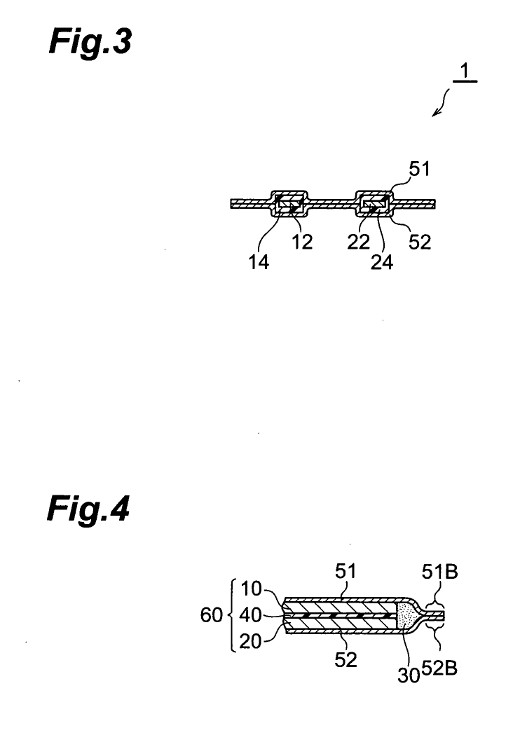

FIG. 1 is a front view showing an example of electrochemical device (electric double layer capacitor) manufactured by a preferred embodiment of the manufacturing method in accordance with the present invention. FIG. 2 is an unfolded view of the inside of the electrochemical device 1 shown in FIG. 1 as seen in a direction normal to the surface of the anode 10. FIG. 3 is a schematic sectional view of the electrochemical device taken along the line X1-X1 of FIG. 1. FIG. 4 is a schematic sectional view showing a major part of the electrochemical device taken along the line X2-X2 of FIG. 1.

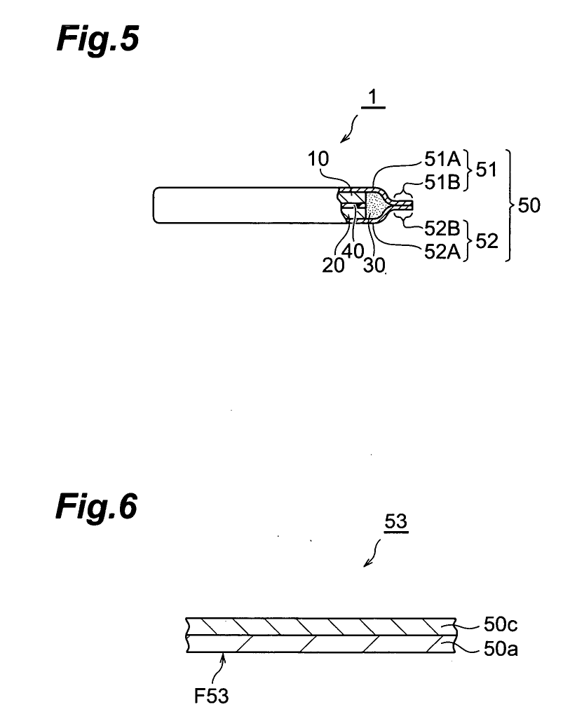

As shown in FIGS. 1 to 5, the electric double layer capacitor 1 is mainly constituted by a planar anode 10 (first electrode) and a planar cathode 20 (second electrode) which oppose each other, a planar separator 40 disposed between the anode 10 and cathode 20 adjacent thereto, an electrolytic solution 30, a case 50 accommodating them in a closed state, an anode lead 12 (first lead) having one end part electrically connected to the anode 10 and the other end part projecting out of the case 50, and a cathode lead 22 (second lead) having one end part electrically connected to the cathode 20 and the other end part projecting out of the case 50. Here, for convenience of explanation, the “anode” 10 and “cathode” 20 are determined according to polarities of the electrochemical device 1 at the time of discharging.

The electrochemical device 1 has a configuration which will be explained in the following. Details of individual constituents of this embodiment will now be explained with reference to FIGS. 1 to 9.

As mentioned above, the case 50 includes a first film 51 and a second film 52 which oppose each other. Here, the first film 51 and second film 52 are joined to each other in the case 50 as shown in FIG. 2. Namely, the case 50 is formed by folding a rectangular film made of a single composite package film at a fold line X3-X3 shown in FIG. 2, overlaying a set of opposing fringes (a fringe 51B of the first film 51 and a fringe 52B of the second film 52 in the drawing) onto each other, and heat-sealing (thermally fusing) them in a thermal fusion step which will be explained later.

The first film 51 and second film 52 refer to respective parts of a rectangular film having opposing faces (F51 and F52) formed when folded as mentioned above. Here, the respective fringes of the first film 51 and second film 52 after being joined together are referred to as “seal parts”.

This makes it unnecessary to provide a seal part for joining the first film 51 and second film 52 to each other at the part of fold line X3-X3, whereby the seal parts in the case 50 can further be reduced. As a result, the volume energy density based on the volume of a space where the electrochemical device 1 is to be placed can further be improved.

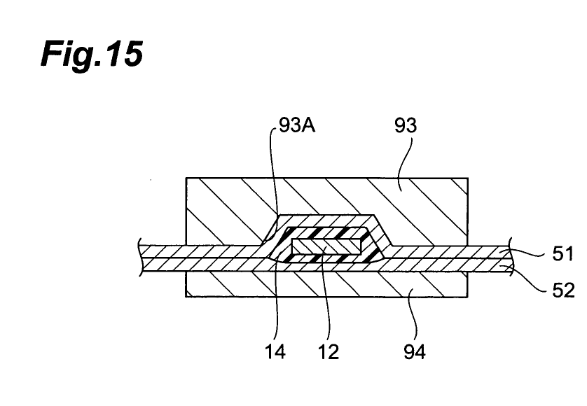

In this embodiment, as shown in FIGS. 1 and 2, the respective one ends of the anode lead 12 connected to the anode 10 and the cathode lead 22 are arranged so as to project out of the above-mentioned seal parts joining the fringe 51B of the first film 51 and the fringe 52B of the second film 52 to each other. The anode lead 12 and cathode lead 22 are heat-sealed (thermally fused) to the fringe 51B of the first film 51 and the fringe 52B of the second film 52 with a mold 93 (see FIG. 15) which is a heating member formed with grooves as will be explained later. This secures a sufficient sealability in the case 50.

As explained above, the film constituting the first film 51 and second film 52 is a film having a flexibility. The film is light in weight and is easy to become thinner, whereby the electrochemical device 1 itself can be formed like a thin film. This can easily improve the original volume energy density, and the volume energy density based on the volume of the space where the electrochemical device 1 is to be placed.

The film is not restricted in particular as long as it is a film having a flexibility. From the viewpoint of effectively preventing moisture and air from entering the inside of the case 50 from the outside and electrolyte components from dispersing from the inside of the case 50 to the outside thereof, while securing a sufficient mechanical strength and lightweightness, it will be preferred if the film is a “composite package film” comprising, at least, an innermost layer made of a synthetic resin coming into contact with the electrolytic solution, and a metal layer disposed above the innermost layer.

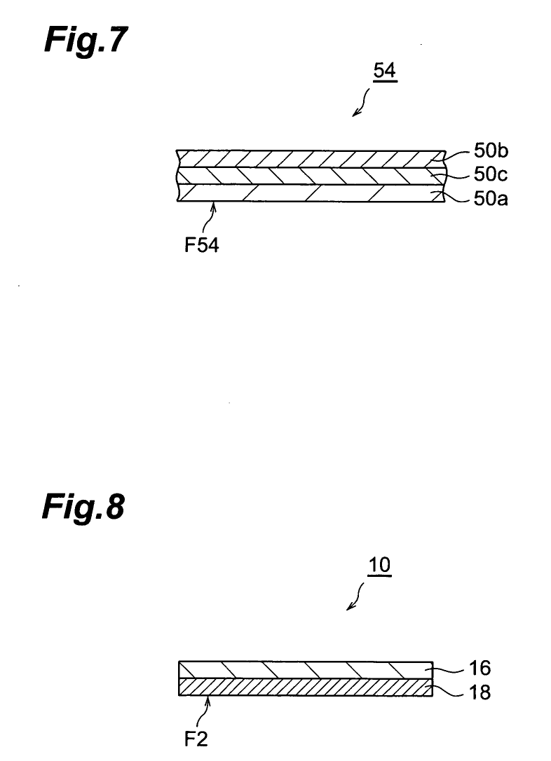

Examples of the composite package film usable as the first film 51 and second film 52 include those having configurations shown in FIGS. 6 and 7.

The composite package film 53 shown in FIG. 6 comprises an innermost layer 50a made of a synthetic resin having an inner face F50a coming into contact with the electrolytic solution, and a metal layer 50c disposed on the other face (outer face) of the innermost layer 50a. The composite package film 54 shown in FIG. 7 has a configuration further comprising an outermost layer 50b disposed on the outer face of the metal layer 50c in the composite package film 53 shown in FIG. 6.

The composite package film usable as the first film 51 and second film 52 is not restricted in particular as long as it is a composite package material including at least two layers comprising at least one layer made of a synthetic resin such as the above-mentioned innermost layer 50a and the metal layer 50c such as a metal foil. However, from the viewpoint of more reliably attaining effects similar to those mentioned above, it will be more preferable if the composite package film is constituted by at least three layers including the innermost layer 50a, the outermost layer 50b made of a synthetic resin disposed on the side of the outer surface of the case 50 the remotest from the innermost layer 50a, and at least one metal layer 50c disposed between the innermost layer 50a and the outermost layer 50b as in the composite package film 54 shown in FIG. 7.

The innermost layer 50a is a layer having a flexibility. Its constituent material is not restricted in particular as long as the material is a synthetic resin which can manifest the above-mentioned flexibility while exhibiting a chemical stability (a property of not causing chemical reactions, dissolution, and swelling) against the electrolytic solution for use and a chemical stability against oxygen and water (moisture in the air). However, a material further exhibiting a low permeability to oxygen, water (moisture in the air), and components of the electrolytic solution is preferred. Examples of the material include thermoplastic resins such as polyethylene, polypropylene, acid-denatured polyethylene, acid-denatured polypropylene, polyethylene ionomer, and polypropylene ionomer.

When a layer made of a synthetic resin such as the outermost layer 50b is further provided in addition to the innermost layer 50a as in the composite package film 54 shown in FIG. 7 mentioned above, this synthetic resin layer may use a constituent material similar to that of the innermost layer. As this synthetic resin layer, a layer made of engineering plastics such as polyethylene terephthalate (PET) and polyamide (nylon) may also be used, for example.

From the viewpoint of productivity, the method of sealing all the seal parts in the case 50 is preferably heat sealing (thermal fusion). In particular, the seal parts in portions where the anode lead 12 and cathode lead 22 project out of the case 50 in this electrochemical device are sealed by heat sealing (thermal fusion).

Preferably, the metal layer 50c is a layer formed from a metal material exhibiting a corrosion resistance to oxygen, water (moisture in the air), and the electrolytic solution. For example, metal foils made of aluminum, aluminum alloys, titanium, nickel, and the like may be used.

When the first film 51 and second film 52 form a substantially rectangular film as shown in FIG. 1, the fringe 51B of the first film 51 and the fringe 52B of the second film 52 to become a seal part preferably have such a size that, with respect to the length A1 in the longitudinal direction of the film (the direction parallel to the line Y-Y in FIG. 1), the width H1 (the thickness in the direction identical to the longitudinal direction of the film) of the seal part is at least 0.5 mm, while (A1/H1) satisfies the condition of 5 or greater. This condition is one when the seal part is formed at only one end of the film as shown in FIG. 1. When seal parts are formed at both ends of the film, it will be preferred if the width H3 (=2H1) of the seal part with respect to the length A1 of the film in the longitudinal direction is such that (A1/H3) satisfies the condition of 10 or greater. Also, it will be preferred if, with respect to the length A2 of the film in the lateral direction (the direction parallel to the line X1-X1 in FIG. 1), the width H2 of the seal part (the thickness in the direction identical to the lateral direction of the film) for each side is at least 0.5 mm, while (A2/H2) satisfies the condition of 2.5 or greater.

When the above-mentioned (A1/H1), (A1/H3), and (A2/H2) are less than their respective lower limits mentioned above, it becomes harder to secure the sealability of the case 50 sufficiently. Also, when the above-mentioned (A1/H1), (A1/H3), and (A2/H2) are lower than their respective ratios mentioned above, the “volume energy density based on the volume of the space to be placed” of the electrochemical device 1 is harder to secure sufficiently.

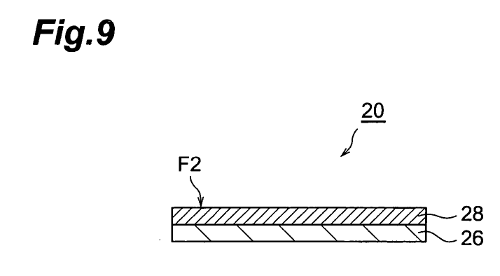

The anode 10 and cathode 20 will now be explained. FIG. 8 is a schematic sectional view showing an example of basic configuration of the anode 10 in the electrochemical device shown in FIG. 1. FIG. 9 is a schematic sectional view showing an example of basic configuration of the cathode 20 in the electrochemical device 1 shown in FIG. 1.

As shown in FIG. 8, the anode 10 comprises a collector layer 16 made of a collector having an electronic conductivity, and a porous layer 18 made of a porous body having an electronic conductivity formed on the collector layer 16. As shown in FIG. 9, the cathode 20 comprises a collector layer 26 made of a collector having an electronic conductivity, and a porous layer 28 made of a porous body having an electronic conductivity formed on the collector layer 26.

The collectors 16 and 26 are not restricted in particular as long as they are conductors which can sufficiently transfer electric charges to their corresponding porous layers 18 and 28, whereby collectors used in known electric double layer capacitors can be employed. Examples of the collector layers 16 and 26 include foils of metals such as aluminum.

Constituent materials of the porous layers 18 and 28 are not restricted in particular, whereby materials similar to those used in porous layers constituting polarizable electrodes such as carbon electrodes used in known electric double layer capacitors can be employed. For example, those whose constituent materials are mainly composed of carbon materials (e.g., activated carbon) obtained by activating coking coal (e.g., petroleum coke made by a delayed coker from material oils such as bottom oils of fluidized catalytic crackers for petroleum-based heavy oils and residual oils of vacuum distillers) can be used. The other conditions (species and contents of constituent materials such as binders other than the carbon material) are not restricted in particular. For example, a conductive auxiliary agent (carbon black or the like) for yielding a conductivity, and a binder (polytetrafluoroethylene, which will hereinafter be referred to as PTFE) may be added to carbon powder.

The separator 40 disposed between the anode 10 and cathode 20 is not restricted in particular as long as it is formed from a porous body having an ion permeability and an insulating property, whereby separators used in known electrochemical capacitors such as electric double layer capacitors can be employed. Examples of the insulating porous body include laminates of films made of polyethylene, polypropylene, and polyolefin, extended films of mixtures of the resins mentioned above, and fibrous nonwoven made of at least one species of constituent material selected from the group consisting of cellulose, polyester, and polypropylene.

However, from the viewpoint of fully securing a contact interface with the electrolytic solution, it will be preferred if the void volume of the porous layer 18 is 50 to 75 μL when the porous layer volume is 100 μL. The void volume of the porous layer 18 can be determined by a known method, which is not restricted in particular.

The collector 28 of the cathode 20 is electrically connected to one end of the cathode lead 22 made of aluminum, for example, whereas the other end of the cathode lead 22 extends to the outside of the case 50. On the other hand, the collector 18 of the anode 10 is electrically connected to one end of the anode lead conductor 12 made of copper or nickel, for example, whereas the other end of the anode lead conductor 12 extends to the outside of the case 50.

The inner space of the case 50 is filled with the electrolytic solution 30, a part of which is contained in the anode 10, cathode 20, and separator 40.

The electrolytic solution 30 is not restricted in particular, whereby electrolytic solutions (aqueous electrolytic solutions and electrolytic solutions using organic solvents) used in known electrochemical capacitors such as electric double layer capacitors can be employed. In the case of an electric double layer capacitor, however, an electrolytic solution using an organic solvent (nonaqueous electrolytic solution) is preferably employed, since the aqueous electrolytic solutions have such an electrochemically low decomposition voltage that the tolerable voltage of the capacitor is limited to a low level.

The species of the electrolytic solution 30 is not restricted in particular, but is chosen in view of the solubility and degree of dissociation of solutes and the viscosity of the liquid in general, and is preferably an electrolytic solution having a high conductivity and a high potential window (high decomposition start voltage). Typical examples for use include those in which quaternary ammonium salts such as tetraethylammonium tetrafluoroborate are dissolved in organic solvents such as propylene carbonate, diethylene carbonate, and acetonitrile. In this case, it is necessary to control the mingling moisture strictly.

As shown in FIGS. 1 and 2, the part of the anode lead 12 coming into contact with the seal part of the case constituted by the fringe 51B of the first film 51 and the fringe 52B of the second film 52 is covered with an adhesive layer 14 made of an adhesive (insulator) for sufficiently securing the adhesion between the anode lead 12 and each film and preventing the anode lead 12 and the metal layer 50c in the composite package film constituting the individual films from electrically coming into contact with each other. Further, the part of the cathode lead 22 coming into contact with the seal part of the case constituted by the fringe 51B of the first film 51 and the fringe 52B of the second film 52 is covered with an adhesive layer 24 made of an adhesive (insulator) for sufficiently securing the adhesion between the anode lead 12 and each film and preventing the cathode lead 22 and the metal layer 50c in the composite package film constituting the individual films from electrically coming into contact with each other.

The adhesive to become a constituent material of the adhesive layers 14 and 24 is not restricted in particular as long as it is an adhesive containing a synthetic resin which can firmly adhere to both of a metal and a synthetic resin, but preferably is an adhesive containing at least one species of resin selected from the group consisting of denatured polypropylene, denatured polyethylene, and an epoxy resin from the viewpoint of securing a sufficient adhesion. The adhesive layers 14 and 24 may be omitted if the adhesion of the composite package film to each of the anode lead 12 and cathode lead 22 can be secured while sufficiently preventing the leads from coming into contact with the metal layer in the composite package film.

Each of the anode lead 12 and cathode lead 22 is formed from a member made of a metal. Each lead preferably has a thickness (the thickness in a direction parallel to a substantially normal direction of the seal part of the case 50) of 0.05 to 5.00 mm, more preferably 0.10 to 3.00 mm, further preferably 0.10 to 2.00 mm. Each preferably has a cross-sectional area of 5.0×10⁻⁴ to 1.0 cm², more preferably 0.01 to 0.40 cm². Even when the anode lead 12 and cathode lead 22 each having a thickness of 0.05 mm or greater with a cross-sectional area of 5.0×10⁻⁴ cm² or greater as such are used, the manufacturing method of the present invention can easily and reliably form the case 50 excellent in sealability, and thus can construct an electrochemical device 1 having such an excellent reliability that the leakage can fully be prevented from occurring.

A method (a preferred embodiment of the manufacturing method in accordance with the present invention) of making the above-mentioned case 50 and electrochemical device 1 (electric double layer capacitor) will now be explained.

First, an example of method of manufacturing a matrix 60 (a laminate in which the anode 10, separator 40, and cathode 20 are successively laminated in this order) will be explained.

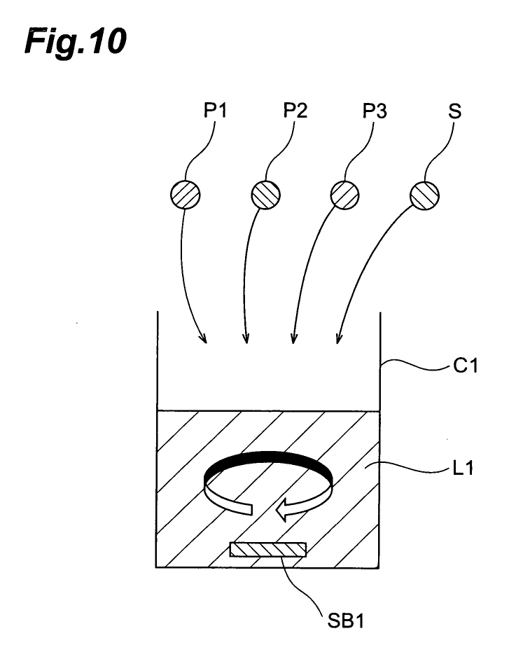

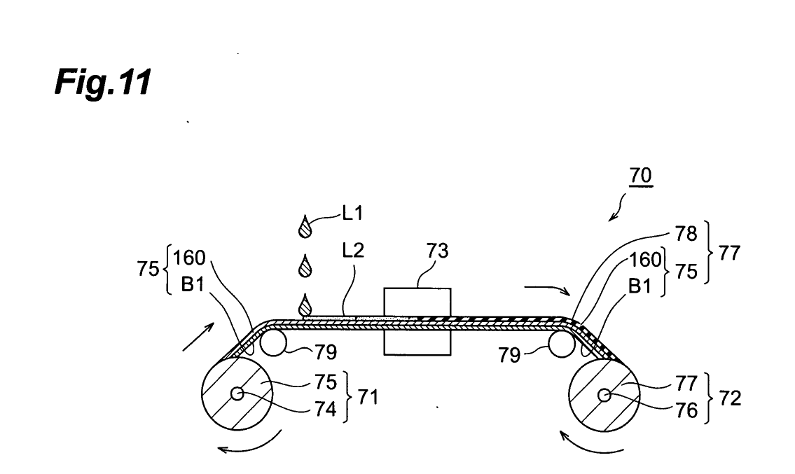

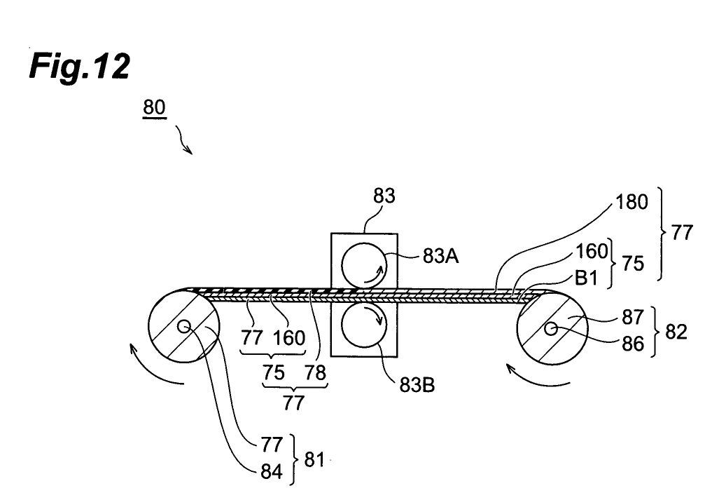

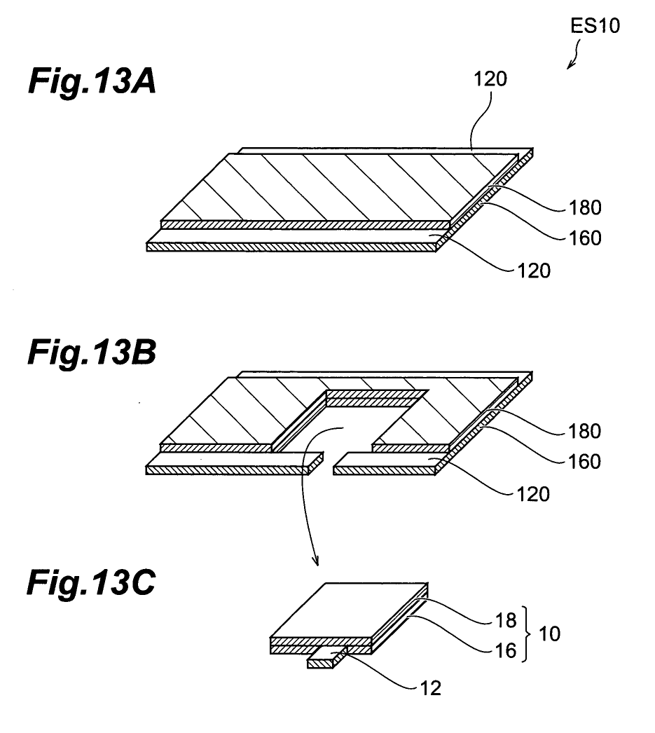

In the following, a preferred example of the manufacturing method in the case where electrodes to become the anode 10 and cathode 20 are carbon electrodes will be explained with reference to FIGS. 10 to 12 and 13A to 13C. FIG. 10 is an explanatory view for explaining a step of preparing an electrode forming coating liquid. FIGS. 11 and 12 are explanatory views for explaining steps of forming an electrode sheet using the electrode forming coating liquid. FIGS. 13A to 13C are explanatory views for explaining steps of forming an electrode from an electrode sheet.

First, when the electrodes to become the anode 10 and cathode 20 are carbon electrodes, a particle P1 made of a carbon material such as activated carbon having a size on the order of 5 to 100 μm, a particle P2 made of a conductive auxiliary agent (such as carbon black mentioned above or powder graphite), a particle P3 made of a binder (such as PTFE, PVDF, PE, PP, or fluorine rubber mentioned above), and a solvent S adapted to dissolve the binder and disperse the particles P1 and P2 are put into a container C1 containing a stirring bar SB1 and stirred as shown in FIG. 10, so as to prepare an electrode forming coating liquid.

When the respective constituent materials of the anode 10 and cathode 20 are different from each other as in the case of manufacturing a secondary battery as an electrochemical device, two kinds of electrode forming coating liquids containing respective particles made of different constituent materials are prepared.

The electrodes may also be manufactured without preparing the above-mentioned electrode forming coating liquid, for example, by pulverizing a carbon material into particles having a size on the order of 5 to 100 μm and adjusting their granularity, thereafter adding a conductive auxiliary agent for yielding a conductivity, for example, and a binder, for example, to the carbon powder, kneading the resulting mixture so as to prepare a kneaded product, and then extending the kneaded product under pressure into a sheet. In this case, it is necessary that fine particles of the pulverized carbon material and carbon black be distributed uniformly and entangled with PTFE fiber by substantially the same strength. Therefore, it will be preferred if the kneading is fully carried out while repetitive extending under pressure is performed in longitudinal and lateral directions in general.

Next, using the above-mentioned electrode forming coating liquid and apparatus 70 and 80 shown in FIGS. 11 and 12, respectively, an electrode sheet is formed. The following will explain the method of forming an electrode sheet ES10 (see FIG. 13A) for the anode 10 and the anode 10 obtained from the electrode sheet ES10, while omitting the method of forming the cathode 20 having a configuration similar to that of the anode 10.

The apparatus 70 shown in FIG. 11 is mainly constituted by a first roll 71, a second roll 72, a dryer 73 disposed between the first roll 71 and second roll 72, and two support rolls 79. The first roll 71 is composed of a cylindrical core 74 and a tape-like laminate sheet 75. One end of the laminate sheet 75 is connected to the core 74, about which the laminate sheet 75 is wound. The laminate sheet 75 has a configuration in which a metal foil sheet 160 is laminated on a base sheet B1.

The second roll 72 includes a cylindrical core 76 to which the other end of the laminate sheet 75 is connected. A core driving motor (not depicted) for rotating the core 76 of the second roll 72 is connected to the core 76, so that a laminate sheet 77 coated with an electrode forming coating liquid L1 and then dried in the dryer 73 is wound at a predetermined speed.

Initially, when the core driving motor revolves, the core 76 of the second roll 72 rotates, whereby the laminate sheet 75 wound about the core 74 of the first roll 71 is drawn out of the first roll 71. Subsequently, the electrode forming coating liquid L1 is applied onto the metal foil sheet 160 of the drawn laminate sheet 75 (coating step). This forms a coating L2 made of the electrode forming coating liquid L1 on the metal foil sheet 160. Next, as the core driving motor revolves, the part of the laminate sheet 75 formed with the coating L2 is guided into the dryer 73 by the support rolls 79. In the dryer 73, the coating L2 on the laminate sheet 75 is dried, so as to form a layer 78 (hereinafter referred to as “precursor layer 78”) to become a precursor of the porous layer 18 when dried to form an electrode. Then, as the core driving motor revolves, the laminate sheet 77 in which the precursor layer 78 is formed on the laminate sheet 75 is guided to and wound about the core 76 by the support rolls 79.

Subsequently, using the above-mentioned laminate sheet 77 and the apparatus 80 shown in FIG. 12, the electrode sheet ES10 is made.

The apparatus 80 shown in FIG. 12 is mainly constituted by a first roll 81, a second roll 82, and a roller press 83 disposed between the first roll 81 and second roll 82. The first roll 81 is composed of a cylindrical core 84 and the above-mentioned tape-like laminate sheet 77. One end of the laminate sheet 77 is connected to the core 84, about which the laminate sheet 77 is wound. The laminate sheet 77 has such a configuration that the precursor layer 78 is further laminated on the laminate sheet 75 in which the metal foil sheet 160 is laminated on the base sheet B1.

The second roll 82 includes a cylindrical core 86 to which the other end of the laminate sheet 77 is connected. A core driving motor (not depicted) for rotating the core 86 of the second roll 82 is connected to the core 86, so that a laminate sheet 87 after being pressed in the roller press 83 is wound at a predetermined speed.

First, when the core driving motor revolves, the core 86 of the second roll 82 rotates, whereby the laminate sheet 77 wound about the core 84 of the first roll 81 is drawn out of the first roll 81. Subsequently, as the core driving motor revolves, the laminate sheet 77 is guided into the roller press 83. Disposed within the roller press 83 are two cylindrical rollers 83A and 83B. The rollers 83A and 83B are arranged such that the laminate sheet 77 can be inserted therebetween. The rollers 83A and 83B are placed such that, when the laminate sheet 77 is inserted between them, the side face of the roller 83A and the outer surface of the precursor layer 78 of the laminate sheet 77 come into contact with each other, whereas the side face of the roller 83B and the outer surface (rear face) of the base sheet B1 of the laminate sheet 77 come into contact with each other, and the laminate sheet 77 can be pressed at a predetermined temperature and pressure.

The cylindrical rollers 83A and 83B are provided with respective rotating mechanisms rotating in a direction conforming to the moving direction of the laminate sheet 77. The length between bottom faces in each of the cylindrical rollers 83A and 83B is not smaller than the width of the laminate sheet 77.

The precursor layer 78 on the laminate sheet 77 is heated and pressed in the roller press 83 as necessary, so as to become a porous layer 180 (the porous layer 18 when formed into an anode). Then, as the core driving motor revolves, the laminate sheet 87 in which the porous layer 180 is formed on the laminate sheet 77 is wound about the core 86.

Next, as shown in FIG. 13A, the laminate sheet 87 wound about the core 86 is cut into a predetermined size, so as to yield the electrode sheet ES10. The electrode sheet ES10 shown in FIG. 13A is formed with fringes 120 at which the surface of the metal foil sheet 160 is exposed. The fringes 120 can be formed when the electrode forming coating liquid L1 is adjustably applied to only the center part of the metal foil sheet 160 of the laminate sheet 75.

Subsequently, as shown in FIG. 13B, the electrode sheet ES10 is punched out in conformity to the scale of the electrochemical capacitor to be made, whereby the anode 10 shown in FIG. 13C is obtained. If the electrode sheet ES10 is punched out such that a part of the above-mentioned fringes 120 is included as an anode lead 12, the anode 10 in accordance with the present invention can be obtained in a state integrated with the anode lead 12 beforehand. If not connected beforehand, the anode lead conductor 12 and cathode lead 22 are separately prepared and electrically connected to the anode 10 and cathode 20, respectively.

Next, a separator 40 prepared separately is disposed between the anode 10 and cathode 20 while in contact therewith, whereby a matrix 60 is completed.

The separator 40 disposed between the anode 10 and cathode 20 in the electrochemical device 1 has one surface in contact with the surface (hereinafter referred to as “inner face”) of the anode 10 on the cathode 20 side and the other surface in contact with the surface (hereinafter referred to as “inner face”) of the cathode 20 on the anode 10 side. Namely, the separator 40 is in contact with the anode 10 and cathode 20 but is not joined to them by thermocompression bonding or the like.

When the separator 40 is joined to the anode 10 and cathode 20 by thermocompression bonding or the like, 1) micropores or voids in both electrodes contributing to forming an electric double layer are collapsed, and 2) micropores in the separator 40 are partly collapsed, whereby the internal resistance increases. When the electrochemical capacitor is used as a small-size electrochemical capacitor having a small capacitor capacity mounted to a small-size electronic device, a small difference in internal resistance (impedance) remarkably affects discharging characteristics. As the internal resistance increases, the ohmic loss (IR loss) becomes greater, thereby lowering discharging characteristics. In particular, the ohmic loss may become so much that a large current cannot be discharged. Therefore, the electrochemical device 1 (electric double layer capacitor) employs a configuration in which the separator 40 is in contact with the anode 10 and cathode 20 as mentioned above.

When a configuration in which the separator 40 is in contact with the anode 10 and cathode 20 as mentioned above is employed, it is necessary that the contact state between the separator 40 and anode 10 and the contact state between the separator 40 and the cathode 20 be regulated so as to minimize their respective voids. When the contact state between the separator 40 and anode 10 and the contact state between the separator 40 and anode 20 are insufficient, the internal resistance of the electrochemical device 1 (electric double layer capacitor) increases, so that discharging characteristics deteriorate.

A method of making the case 50 will now be explained. When forming the first and second films from the above-mentioned composite package film, known manufacturing methods such as dry lamination, wet lamination, hotmelt lamination, and extrusion lamination are used.

For example, a film to become a layer made of a synthetic resin constituting the composite package film, and a metal foil made of aluminum or the like are prepared. The metal foil can be prepared by extending a metal material, for example.

Next, the metal foil is bonded onto the film to become the layer made of the synthetic resin by way of an adhesive, and so forth, so as to yield a configuration preferably comprising a plurality of layers as mentioned above, thereby making a composite package film (multilayer film). Then, the composite package film is cut into a predetermined size, so as to prepare a rectangular film.

Subsequently, in the fringes to be thermally fused in the rectangular film, the portion coming into contact with the anode lead 12 and cathode lead 22 is drawn so as to attain forms and sizes in conformity to those of respective cross sections of the anode lead 12 and cathode lead 22. The portion accommodating the matrix 60 may also be drawn.

In this case, it will be sufficient if at least one of the seal part 51B on the side to become the first film 51 and the seal part 52B on the side to become the second film 52 is drawn.

Subjecting the rectangular film to the above-mentioned drawing can secure a sufficient sealability in the case 50 even when leads made of a metal having a thickness of 0.05 to 5.00 mm, 0.10 to 2.00 mm in particular, are used as the anode lead 12 and cathode lead 22.

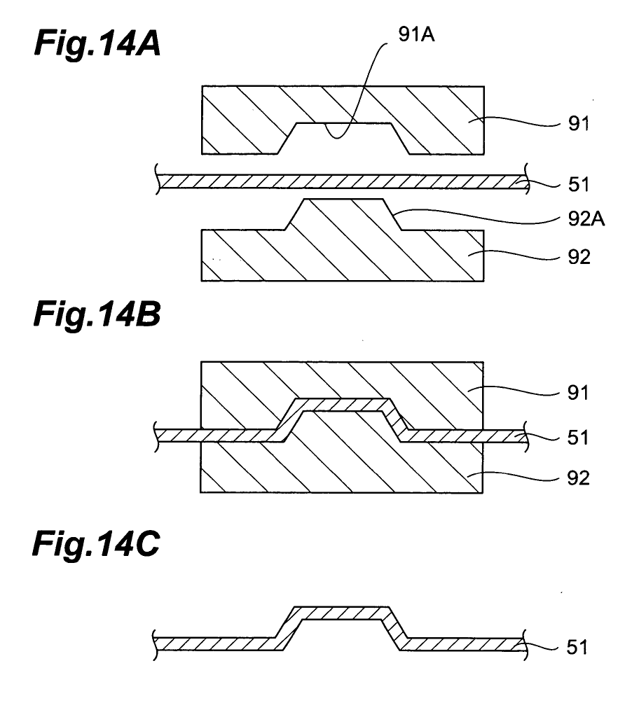

A procedure of subjecting the rectangular film to the above-mentioned drawing will be explained with reference to FIGS. 14A to 14C while taking the case of processing the seal part 51B on the side to become the first film 51 as an example. FIGS. 14A to 14C are explanatory views for explaining a procedure of drawing the seal part 51B of the first film 51.

First, as shown in FIG. 14A, the portion to be processed in the seal part 51B of the first film 51 is disposed between a die 91 which is a first heating member formed with a groove 91A (depression) having a form and a size in conformity to those of the cross section of the anode lead 12 for use and a die 92 which is a second heating member having a projection 92A taking account of the thickness of the first film 51 and the form and size of the groove 91A. In the case of FIGS. 14A and 14B, the form and size of the groove 91A are such as to become substantially trapezoidal in view of the thickness and cross-sectional form of the first film 51 brought into close contact with the anode lead 12 while being thermally deformed in a thermal fusion step which will be explained later.

Next, as shown in FIG. 14B, the surface of the die 91 formed with the groove 91A and the projection 92A of the die 92 are caused to mate with each other, such that the portion to be processed in the first film is gradually pressed and deformed. Here, at least one of the dies 91 and 92 may be heated so as to attain a predetermined temperature (e.g., 20 to 90° C.).

This yields the first film 51 having a form in conformity to the form and size of the cross section of the anode lead 12 shown in FIG. 14C. When drawing for yielding a form in conformity to the form and size of the cross section of the cathode lead 22 is carried out simultaneously with or separately from the drawing mentioned above, the first film 51 having the respective portions having forms and sizes in conformity to those of the anode lead 12 and cathode lead 22 can be obtained. The drawing for the cathode lead 22 can be carried out simultaneously with the drawing for the anode lead 12, for example, by providing the molds 91 and 92 with an additional groove and projection.

Next, as previously explained with reference to FIG. 2, a single film is folded, and the matrix 60 is disposed therein. Here, the anode lead conductor 12 and cathode lead 22 are fitted to the portion deformed by the drawing in the seal part 51B of the first film 51.

Next, in the contact parts to be thermally fused in the first film 51 and second film 52, the portion where the first and second leads are disposed between the fringe (seal part 51B) to be thermally fused in the first film 51 and the fringe (seal part 52B) to be thermally fused in the second film 52 is thermally fused by the following procedure (thermal fusion step).

The above-mentioned thermal fusion step will now be explained with reference to FIG. 15 while a case of thermally fusing surroundings of the anode lead conductor 12 to the first film 51 and second film 52 is taken as an example. FIG. 15 is an explanatory view for explaining the procedure of thermally fusing the surroundings of the anode lead conductor 12 to the first film 51 and second film 52 by the thermal fusion step.

First, as shown in FIG. 15, a laminate constituted by the portion to be thermally fused in the seal part 51B of the first film 51, the anode lead 12, and the portion to be thermally fused in the seal part 52B of the film 52 is disposed between a first thermal fusion die 93 which is a heating member formed with a groove 93A having a form and a size in conformity to those of the cross section of the anode lead 12 for use and a flat second thermal fusion die 94 which is a heating member. In the case of FIG. 15, the form and size of the groove 93A are such as to become substantially trapezoidal in view of the thickness and cross-sectional form of the first film 51 brought into close contact with the anode lead 12 while being thermally deformed.

Here, from the viewpoint of more reliably yielding a sufficient sealability in the case 50, it will be preferred if the surface of the anode lead 12 is coated with the above-mentioned adhesive as shown in FIG. 15. As a consequence, between the anode lead 12 and the first film 51 and second film 52, an adhesive layer 14 made of the adhesive contributing to the adhesion is formed after the thermal fusion step.

Not only the first thermal fusion die 93 as a heating member is provided with the groove 93A (depression), but also the second thermal fusion die 94 as a heating member may be provided with a groove taking account of the thickness of the first film 51 and the form and size of the groove 91A.

Next, as shown in FIG. 15, at least one member of the first thermal fusion die 93 and second thermal fusion die 94 is heated while the contact portion of the first film 51 and second film 52 is pressed, so as to melt the above-mentioned contact portion, thereby thermally fusing the first film 51 and second film 52 to each other. Here, at least one member of the first thermal fusion die 93 and second thermal fusion die 94 is heated so as to attain a predetermined temperature (e.g., 140 to 200° C.). When pressurizing under the temperature condition of 140 to 200° C., it will be preferred if the pressure applied to the contact portion is 9.80×10⁴ to 49.0×10⁴ Pa.

In a procedure similar to that explained in the foregoing, a thermal fusion process for surroundings of the cathode lead 22 is carried out simultaneously with or separately from the thermal fusion process mentioned above, whereby the case having a sufficient sealability can be formed. The thermal fusion process for the portion surrounding the cathode lead 22 can be carried out simultaneously with the thermal fusion process for the portion surrounding the anode lead 12, for example, by providing the first thermal fusion mold 93 with an additional groove.

Subsequently, the portion other than the above-mentioned surrounding portions of the anode lead 12 and cathode lead 22 in the seal part 51B (fringe 51B) of the first film 51 and the seal part 52B (fringe 52B) of the second film is heat-sealed (thermally fused) by a desirable seal width, for example, with a sealer under a predetermined heating condition.

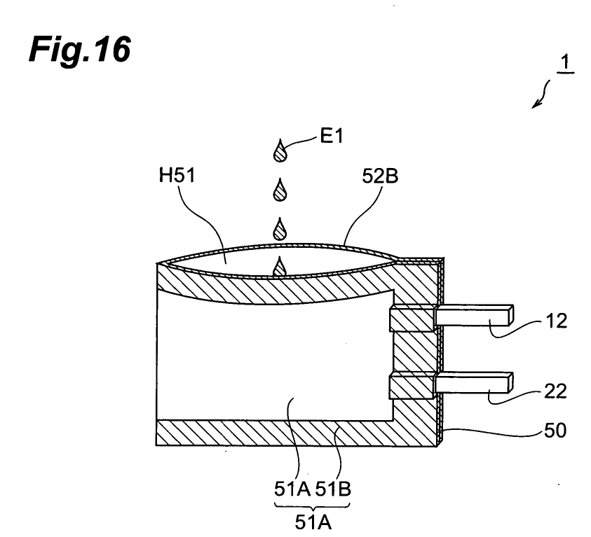

Here, as shown in FIG. 16, a part free of heat sealing is provided in order to secure an opening H51 for injecting the electrolytic solution 30. This yields the case 50 with the opening H51.

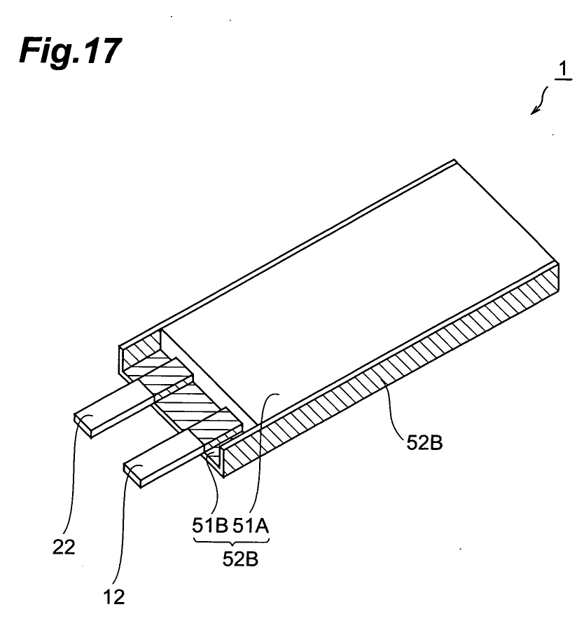

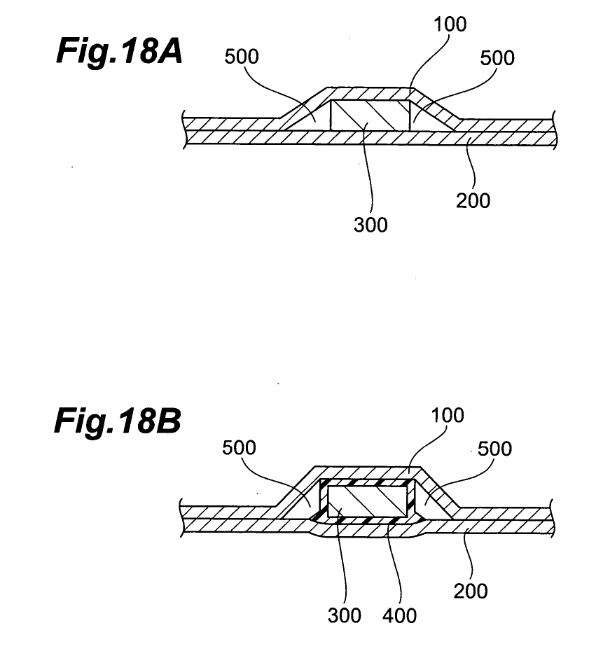

Then, as shown in FIG. 16, the electrolytic solution 30 is injected from the opening H51. Subsequently, a vacuum sealer is used for sealing the opening H51 of the case 50. Further, from the viewpoint of improving the volume energy density based on the space where the resulting electrochemical device 1 is to be placed, the seal parts of the case 50 are bent as shown in FIG. 17 when necessary. Thus, the making of the case 50 and electrochemical device 1 (electric double layer capacitor) is completed.

Though the preferred embodiment of the present invention is explained in detail in the foregoing, the present invention is not limited thereto. For example, in the explanation of the above-mentioned embodiment, seal parts of the electrochemical device 1 may be bent, so as to form a more compact configuration. Though the electrochemical device 1 comprising the anode 10 and cathode 20 one by one is explained in the above-mentioned embodiment, more than one set of anode 10 and cathode 20 with one separator 40 always being disposed therebetween may be provided.

Though the above-mentioned embodiment mainly relates to the making of an electric double layer capacitor by the manufacturing method of the present invention, the electrochemical device made by the manufacturing method of the present invention is not limited to the electric double layer capacitor. For example, the manufacturing method of the present invention is also applicable to the making of electrochemical capacitors such as pseudocapacity capacitors, pseudocapacitors, and redox capacitors.

Further, the manufacturing method of the present invention is applicable to the making of a secondary battery such as a lithium-ion secondary battery comprising first and second electrodes opposing each other, a separator disposed between the first and second electrodes adjacent thereto, and an electrolytic solution, which are accommodated in a case made of a film having a flexibility.

In the following, the electrochemical capacitor in accordance with the present invention will be explained in more detail with reference to Examples and Comparative Examples, which do not restrict the present invention at all.

### EXAMPLE 1

In the following procedure, an electrochemical capacitor (electric double layer capacitor) having the same configuration as with the electrochemical capacitor shown in FIG. 1 was made.

(1) Making of Electrode

An anode (polarizable electrode) and a cathode (polarizable electrode) were made by the following procedure. First, an activated carbon material, a binder (fluorine rubber), and a conductive auxiliary agent (acetylene black) were compounded such that the mass ratio of carbon material/binder/conductive auxiliary agent=80:10:10, and the resulting product was put into MIBK (methyl isobutyl ketone) and kneaded therein, so as to prepare an electrode forming coating liquid (hereinafter referred to as “coating liquid L1”).

Next, the coating liquid L1 was uniformly applied onto one surface of a collector (having a thickness of 50 μm) made of an aluminum foil (both faces of collectors in electrodes disposed within a matrix since a plurality of anodes, separators, and cathodes were used for forming the matrix). Then, the liquid component was eliminated from the coating by drying, and the laminate composed of the collector and the dried coating was pressed with pressure rolls, so as to make an electrode (hereinafter referred to as “electrode E1”) in which an electronically conductive porous layer (having a thickness of 37 μm) was formed on one surface of the collector (having a thickness of 50 μm) made of the aluminum foil. Subsequently, this electrode E1 was cut into a rectangle (having a size of 120.0 mm×100.0 mm), which was then dried under vacuum for at least 12 hours at a temperature of 150° C. to 175° C., so as to remove the moisture absorbed by the surface of the electronically conductive porous layer, thereby making the anode and cathode to be mounted to the electrochemical device in accordance with Example 1 having a size regulated by punching.

The coating liquid L1 was adjustably applied to the aluminum foil such that fringes of the aluminum foil were free of the coating liquid L1, whereby the anode and cathode each integrally formed beforehand with a lead (having a width of 10 mm, a length of 8 mm, and a thickness of 50 μm) shown in FIG. 13C were obtained.

(2) Making of Electrochemical Capacitor

First, the anode and cathode were opposed to each other, a separator made of a regenerated cellulose nonwoven fabric (120.5 mm×100.5 mm with a thickness of 0.05 mm) was disposed therebetween, and a laminate (matrix) in which the anode, separator, and cathode were laminated in this order was formed. By ultrasonic welding, respective leads (each having a width of 10 mm, a length of 25 mm, and a thickness of 0.50 mm) were connected to the anode and cathode of this laminate.

Subsequently, as a flexible composite package film, a laminate (having a thickness of 20 μm and a size of 130.0 mm×10.0 mm) in which an innermost layer made of a synthetic resin (a layer made of denatured polypropylene having a thickness of 40 μm) in contact with the electrolytic solution, a metal layer (having a thickness of 40 μm) made of an aluminum foil, and a layer made of polyamide (having a thickness of 20 μm) were successively laminated in this order was prepared.

Next, in a procedure similar to that previously explained with reference to FIGS. 14A to 14C, the portion where the anode lead and cathode lead were placed in a fringe of one of two composite package films was drawn. The cross-sectional form of the groove 91A in the die 91 was a trapezoid (having an upper base of 10.3 mm, a lower base of 10.5 mm, and a height (thickness) of 0.50 mm) similar to that shown in FIG. 14A. The drawing was carried out at room temperature (about 23° C.) with a pressure of 49.0×10⁴ to 98.1×10⁴ Pa applied to the fringe of the composite package films.

Subsequently, the two composite package films were folded, and the matrix 60 was disposed therein. Here, the anode lead conductor 12 and cathode lead 22 were fitted into the respective portions deformed by the drawing in the composite package films.

At that time, surroundings of the anode lead and cathode lead were coated with acid-denatured polypropylene films (each having a thickness of 100 μm) acting as the above-mentioned adhesive layers 14 and 24, respectively.

Then, by a procedure similar to that previously explained with reference to FIG. 15, the surroundings of the anode lead and cathode lead were subjected to thermal fusion. The cross-sectional form of the groove 93A in the first thermal fusion die 93 was a trapezoid (having an upper base of 10.3 mm, a lower base of 10.5 mm, and a height (thickness) of 0.50 mm) similar to that shown in FIG. 15. The thermal fusion was carried out for 10 seconds at 185° C. under a condition where a pressure of 49.0×10⁴ Pa was applied to the fringe of the composite package films.

Next, in the seal parts of the two composite package films, the portion other than the above-mentioned surrounding portions of the anode lead 12 and cathode lead 22 was heat-sealed (thermally fused) by a seal width of 4 mm with a sealer. Here, an unsealed part was provided in order to secure an opening for injecting the electrolytic solution 30 as shown in FIG. 16.

Subsequently, an electrolytic solution (a propylene carbonate solution containing 1.0 mol/L of triethylmethylammonium tetrafluoroborate) was injected into the case from the above-mentioned opening. Subsequently, the opening H51 of the case 50 was sealed with a vacuum sealer. Thus, an electrochemical device was made.

### EXAMPLE 2

In place of the leads used in Example 1, those having a different thickness (with a width of 10 mm, a length of 25 mm, and a thickness of 3.00 mm) were employed. Accordingly, an electrochemical device was made by the same procedure under the same condition as with the electrochemical device of Example 1 except that the cross-sectional form of the groove 91A of the die 91 used for drawing was a trapezoid (having an upper base of 10.3 mm, a lower base of 10.5 mm, and a height (thickness) of 3.00 mm), and that the cross-sectional form of the groove 93A of the first thermal fusion die 93 used for thermal fusion was a trapezoid (having an upper base of 10.3 mm, a lower base of 10.5 mm, and a height (thickness) of 3.00 mm).

### EXAMPLE 3

In place of the leads used in Example 1, those having a different thickness (with a width of 10 mm, a length of 25 mm, and a thickness of 0.10 mm) were employed. Accordingly, an electrochemical device was made by the same procedure under the same condition as with the electrochemical device of Example 1 except that the cross-sectional form of the groove 91A of the die 91 used for drawing was a trapezoid (having an upper base of 10.3 mm, a lower base of 10.5 mm, and a height (thickness) of 0.10 mm), and that the cross-sectional form of the groove 93A of the first thermal fusion die 93 used for thermal fusion was a trapezoid (having an upper base of 10.3 mm, a lower base of 10.5 mm, and a height (thickness) of 0.10 mm).

### EXAMPLE 4

An electrochemical device was made by the same procedure under the same condition as with the electrochemical device of Example 1 except that the drawing carried out in Example 1 was not performed.

### COMPARATIVE EXAMPLE 1

An electrochemical device was made by the same procedure under the same condition as with the electrochemical device of Example 1 except that the drawing carried out in Example 1 was not performed, and that a flat first thermal fusion heating member formed with no groove and a flat second thermal fusion heating member were used in the thermal fusion.

### COMPARATIVE EXAMPLE 2

In place of the leads used in Example 1, those having a different thickness (with a width of 10 mm, a length of 25 mm, and a thickness of 4.00 mm) were employed. An electrochemical device was made by the same procedure under the same condition as with the electrochemical device of Example 1 except that the drawing carried out in Example 1 was not performed, and that the cross-sectional form of the groove 93A of the first thermal fusion die 93 used for thermal fusion was a trapezoid (having an upper base of 10.3 mm, a lower base of 10.5 mm, and a height (thickness) of 3.00 mm).

### COMPARATIVE EXAMPLE 3

In place of the leads used in Example 1, those having a different thickness (with a width of 10 mm, a length of 25 mm, and a thickness of 3.00 mm) were employed. An electrochemical device was made by the same procedure under the same condition as with the electrochemical device of Example 1 except that the drawing carried out in Example 1 was not performed, and that a flat first thermal fusion heating member formed with no groove and a flat second thermal fusion heating member were used in the thermal fusion.

Characteristic Evaluation Tests of Electrochemical Capacitors

The following characteristics of the electrochemical devices (electric double layer capacitors) in accordance with Examples 1 to 4 and Comparative Examples 1 to 3 were determined.

First, using a charging/discharging tester, low-current charging was performed at 0.5 C, while monitoring the rise in voltage as each electric double layer capacitor accumulated electric charges. After the potential reached 2.5 V, the charging was shifted to constant voltage charging (moderate charging), and the charging was terminated when the current became 1/10 of the charging current. Here, the total charging time (i.e., charging time+moderate charging time) depended on the capacitance of the cell. Then, constant-current discharging at 0.5 C was performed for discharging until the final voltage became 0 V. After this test, charging was performed with a current of 1 C, and was shifted to constant-voltage charging after the potential reached 2.5 V. The charging was terminated when the current became 1/10 of the charging current. Then, constant-current discharging at 1 C was performed for discharging until the final voltage became 0 V. Thereafter, charging was started again. The foregoing process was repeated 10 times.

The capacity of each electrochemical capacitor (the capacitance of the cell of the electrochemical capacitor) was determined as follows. Namely, the discharging energy (the total charging energy [W·s] as the time integral of discharging voltage×current) was determined from the discharging curve (discharging voltage vs. discharging time), and the capacity (capacitor capacity) [F] of the evaluated cell was determined by using the relational expression of capacitor capacity [F]=2×total discharging energy [W·s]/(discharging start voltage [V])².

Subsequently, the capacity and internal resistance of each electrochemical capacitor were measured at a measurement environment temperature of 25° C. and a relative humidity of 60% (hereinafter referred to as “Evaluation Test 1”). The internal resistance was measured by the following procedure. Namely, the internal resistance was calculated from the amount of change in voltage when a current of 10 mA flowed at a frequency of 1 kHz.

Next, after each electrochemical device was left for 168 hours in an environment with a measurement environmental temperature of 70° C. and a relative humidity of 90%, its capacity and internal resistance at a measurement environmental temperature of 25° C. and a relative humidity of 60% were measured again (hereinafter referred to as “Evaluation Test 2”) by the same procedure under the same condition as with the above-mentioned Evaluation Test 1. Also, the appearance of each electrochemical device after being left for 168 hours in the environment with a measurement environmental temperature of 70° C. and a relative humidity of 90% was visually evaluated.

Table 1 shows results of characteristic evaluation tests of the respective electrochemical devices in accordance with Examples 1 to 4 and Comparative Examples 1 to 3.

TABLE 1

| | EVALUATION TEST1 | | EVALUATION TEST2 | | |
|---|---|---|---|---|---|
| | INTERNAL | | INTERNAL | | VISUAL |
| | RESISTANCE/ | CAPACITOR | RESISTANCE/ | CAPACITOR | APPEARANCE |
| | mΩ | CAPACITY/F | mΩ | CAPACITY/F | EVALUATION |
| EXAMPLE1 | 1.1 | 1001 | 1.2 | 1000 | NO |
| | | | | | ABNORMALITY |
| EXAMPLE2 | 1.1 | 1000 | 1.0 | 998 | NO |
| | | | | | ABNORMALITY |
| EXAMPLE3 | 1.0 | 999 | 1.0 | 998 | NO |
| | | | | | ABNORMALITY |
| EXAMPLE4 | 1.2 | 1000 | 1.1 | 999 | NO |
| | | | | | ABNORMALITY |
| COMPARATIVE | 1.1 | 998 | NOT | NOT | ABNORMALITY |
| EXAMPLE1 | | | MEASURABLE | MEASURABLE | OCCURRED |
| COMPARATIVE | 1.3 | 990 | 2500.0 | NOT | ABNORMALITY |
| EXAMPLE2 | | | | MEASURABLE | OCCURRED |
| COMPARATIVE | NOT | NOT | NOT | NOT | ABNORMALITY |
| EXAMPLE3 | MEASURABLE | MEASURABLE | MEASURABLE | MEASURABLE | OCCURRED |

As can be seen from the results shown in Table 1, it was verified that the respective electrochemical devices in accordance with Examples 1 to 4 were more reliable than those of Comparative Examples.

When the appearance of each electrochemical device left for 168 hours in the environment with a measurement environmental temperature of 70° C. and a relative humidity of 90% was visually evaluated, it was verified that abnormality occurred in the electrochemical devices in accordance with Comparative Examples 1 to 3.

More specifically, it was seen in the electrochemical device of Comparative Example 1 that fine pores existed about the leads, and the moisture mingled into the case by way of the pores and reacted with the electrolytic solution, thereby generating an acid, which corroded the leads, so as to chip them away. The electrochemical device of Comparative Example 2 greatly lowered its characteristics, for example, such that, after the electrochemical device was left in the environment with a measurement environmental temperature of 70° C. and a relative humidity of 90%, the internal resistance increased by 2000 times or more, the measurement of capacity became impossible, and so forth. In the electrochemical device of Comparative Example 3, the electrolytic solution was seen to leak out of the case immediately after making the electrochemical device before the electrochemical device was placed in the environment with a measurement environmental temperature of 70° C. and a relative humidity of 90%, whereby it was not possible to perform all the characteristic evaluation tests.

By contrast, the electrochemical devices in accordance with Examples 1 to 4 were seen to have a sealability without showing abnormality.

### INDUSTRIAL APPLICABILITY

As explained in the foregoing, the manufacturing method of the present invention can provide an electrochemical device which can easily and reliably form a case having an excellent sealability even when a lead having a thickness of 0.05 mm or greater with a cross-sectional area of 5.0×10⁻⁴ cm² or greater is used, while having such an excellent reliability that the leakage can fully be prevented from occurring. Also, the manufacturing method of the present invention can easily provide an electrochemical device having a configuration which can easily reduce its size and weight. In particular, the manufacturing method of the present invention can provide an electrochemical device capable of charging and discharging with a large current (e.g., an electrochemical device capable of charging and discharging at 10 to 200 A).

1. A method of manufacturing an electrochemical device comprising:
an electrochemical device matrix including first and second electrodes opposing each other;
a case, formed by first and second films opposing each other, for accommodating the electrochemical device matrix in a closed state;
a first lead having one end part connected to the first electrode and the other end part projecting out of the case; and
a second lead having one end part connected to the second electrode and the other end part projecting out of the case;
the method including a thermal fusion step of arranging the first and second films such that respective fringes thereof are in contact with each other between a pair of heating members opposing each other, and heating at least one of the pair of heating members while a contact portion of the fringes is pressed, so as to thermally fuse the first and second films to each other;
wherein at least one of the pair of heating members is formed with grooves having respective forms in conformity to forms of cross sections of the first and second leads at a part where the first and second leads are placed between the fringes of the first and second films.

2. A method of manufacturing an electrochemical device according to claim 1, wherein leads made of a metal each having a thickness of 0.05 to 3.00 mm are used as the first and second leads.

3. A method of manufacturing an electrochemical device according to claim 1, wherein a portion coming into contact with the first and second leads in the fringe to be thermally fused in at least one of the first and second films is deformed by drawing beforehand so as to have respective forms and sizes in conformity to forms and sizes of cross sections of the first and second leads; and then
the thermal fusion step is carried out.

4. A method of manufacturing an electrochemical device according to claim 3, wherein leads made of a metal each having a thickness of at least 0.10 mm are used as the first and second leads.

5. A method of manufacturing an electrochemical device according to one of claims 1 to 4, wherein leads made of a metal each having a cross-sectional area of 5.0×10⁻⁴ to 1.0 cm² are used as the first and second leads.

6. A method of manufacturing an electrochemical device according to one of claims 1 to 5, wherein electrodes each having a flat form and containing an electronically conductive porous body as a constituent material are used as the first and second electrodes;
wherein a member made of an insulative porous body having a flat form is used as the separator; and
wherein the electrolytic solution fills the case such that the electrolytic solution is at least partly contained in the first and second electrodes and the separator.

7. A method of manufacturing an electrochemical device according to one of claims 1 to 6, wherein a composite package film comprising at least an innermost layer made of a synthetic resin in contact with an electrolytic solution and a metal layer disposed above the innermost layer is used as the first and second films.

8. A method of manufacturing an electrochemical device according to one of claims 1 to 7, wherein an adhesive made of a synthetic resin is applied beforehand to a surface portion of the first lead coming into contact with the fringe of the first film to be thermally fused and the fringe of the second film to be thermally fused, and to a surface portion of the second lead coming into contact with the fringe of the first film to be thermally fused and the fringe of the second film to be thermally fused, and then the thermal fusion step is carried out.

9. A method of manufacturing an electrochemical device according to claim 8, wherein an adhesive containing at least one species of resin selected from the group consisting of denatured polypropylene, denatured polyethylene, and epoxy resin is used as the adhesive made of a synthetic resin.
